(19) United States
(12) Patent Application Publication
(10) Pub. No.: US 2025/0240382 A1
(43) Pub. Date: Jul. 24, 2025

(54) CONTROL METHOD, INFORMATION PROCESSING APPARATUS, AND STORAGE MEDIUM

(71) Applicant: CANON KABUSHIKI KAISHA, Tokyo (JP)

(72) Inventor: AKIRA NOZAKI, Kanagawa (JP)

(21) Appl. No.: 18/955,585

(22) Filed: Nov. 21, 2024

(30) Foreign Application Priority Data
Jan. 24, 2024 (JP) 2024-008545

(51) Int. Cl. H04N 1/60; G06F 3/12

(52) U.S. Cl. CPC H04N 1/6097; G06F 3/1208; G06F 3/1256; H04N 1/6041

(57) ABSTRACT

A control method of the present disclosure is a control method for an information processing apparatus connected to a printing apparatus includes registering information related to a target custom sheet that is set to the printing apparatus, and transmitting the registered information to the printing apparatus. In which in the registration, whether to allow a user to select first setting, by which correction information is used at printing on a sheet of a kind other than the target custom sheet, is varied depending on whether a predetermined condition is satisfied, the correction information being obtained by using the target custom sheet pertaining to printing data to be printed by a printing unit of the printing apparatus.

### BACKGROUND

### Field

The present disclosure relates to control of the application range of color calibration executed by a printing apparatus.

### Description of the Related Art

In a printing apparatus, the ink discharge amount changes due to aging of a printing head or the like, and thus, even when an image is formed based on the same image data, colors expressed on a printing media such as sheets vary in some cases. Thus, what is called color calibration (hereinafter referred to as calibration) is known that corrects image data input to the printing apparatus to express stable color on the printing media. In calibration, a color patch is printed on the printing media (hereinafter referred to as sheet) by the printing head, color measurement of the color patch is performed, and correction processing of input image data is performed based on the color measurement result.

In Japanese Patent Laid-Open No. 2016-212842 (Patent Document 1), a sheet the calibration result of which is commonly applied to other sheets is referred to as “common calibration sheet”, and a sheet the calibration result of which is applied only to the sheet used during calibration execution is referred to as “individual calibration sheet”. This discloses a technology for delineating the application range of values obtained through calibration.

Regarding genuine sheet for printing apparatus and specific sheet confirmed for printing results by a manufacturer, sheet data set with control parameters and the like of instruments corresponding to the sheet's characteristics is provided for each sheet kind. For third-party sheets for which such sheet data is not provided, a user can produce new sheet data as a “custom sheet”. This “custom sheet” is produced by the user customizing existing sheet data. In a case where the user desires to improve, for example, printing quality and conveyance properties of unspecified sheets such as third party sheets, the user can add and edit “custom sheet”.

However, in the case of a “custom sheet” which specifies that sheet data is produced as an “individual calibration sheet”, it was not possible to produce a “common calibration sheet” for the custom sheet. This is because applying the calibration result to another sheet without issues requires a sheet with which the ink discharge amount difference of the print head can be correctly sensed, in other words, a sheet with predetermined standard characteristics that allow for correct measurement of reflected light during color patch color measurement. However, the characteristics of third-party sheets are diverse and do not necessarily allow for correct measurement of reflected light during color patch color measurement. This is because, when the calibration result obtained by using such a sheet with unknown characteristics is applied to another sheet, the original color may not be reproduced and the calibration function may not be maintained. However, even with a custom sheet, there are those that have predetermined standard characteristics, and uniformly treating them as individual calibration sheets has become a factor that limits the usage form of sheet data.

### SUMMARY

The present disclosure is intended to control so that the color calibration result of a custom sheet can be applied to another sheet.

According to an aspect of the present disclosure, a control method for an information processing apparatus connected to a printing apparatus includes registering information related to a target custom sheet that is set to the printing apparatus, and

transmitting the registered information to the printing apparatus, in which in the registration, whether to allow a user to select first setting, by which correction information is used at printing on a sheet of a kind other than the target custom sheet, is varied depending on whether a predetermined condition is satisfied, the correction information being obtained by using the target custom sheet pertaining to printing data to be printed by a printing unit of the printing apparatus.

Further features of the present disclosure will become apparent from the following description of exemplary embodiments with reference to the attached drawings.

### BRIEF DESCRIPTION OF THE DRAWINGS

FIG. 1 is a diagram illustrating an exemplary configuration of a control system including an information processing apparatus of the present disclosure;

FIG. 2 is a diagram illustrating an exemplary hardware configuration of a printing apparatus;

FIG. 3 is a diagram illustrating an exemplary hardware configuration of a sheet data management apparatus;

FIG. 4 is a diagram illustrating the functional configuration of the control system including the sheet data management apparatus, which is the information processing apparatus of the present disclosure;

FIG. 5 is a diagram illustrating an exemplary configuration of sheet data;

FIG. 6 is a flowchart illustrating the entire process of sheet data edit processing;

FIG. 7 is a flowchart illustrating calibration type setting processing;

FIG. 8 is a diagram illustrating an exemplary UI for setting a calibration type;

FIG. 9 is a flowchart illustrating the process of calibration processing;

FIG. 10 is a diagram illustrating an exemplary configuration of sheet data according to a second embodiment;

FIG. 11 is a flowchart illustrating calibration type setting processing in the second embodiment;

FIG. 12 is a diagram illustrating the hardware configuration of a printing apparatus according to a third embodiment;

FIG. 13 is a diagram illustrating the functional configuration of a control system according to the third embodiment;

FIG. 14 is a flowchart illustrating calibration type setting processing in the third embodiment;

FIG. 15 is a diagram illustrating the functional configuration of a control system according to a fourth embodiment;

FIG. 16 is a diagram illustrating an exemplary UI for instructing calibration execution; and

FIG. 17 is a flowchart illustrating the process of calibration control processing.

### DESCRIPTION OF THE EMBODIMENTS

Embodiments of the present disclosure will be described below in detail with reference to the accompanying drawings. The embodiments below do not limit the present disclosure according to the claims and not all combinations of features described in the embodiments are necessarily essential to means for solution of the present disclosure.

### First Embodiment

A control system according to the present embodiment executes processing for supporting registration (new production and edit) of a custom sheet by a user. The custom sheet is sheet data produced by the user customizing existing sheet data. The custom sheet is produced and edited for the purpose of improving printing quality and conveyance properties of unspecified sheets other than, for example, manufacturer genuine sheets and particular sheets printing quality and the like of which are checked for a printing apparatus according to the present embodiment by the manufacturer. The control system according to the present embodiment controls the application range of correction data acquired during color calibration (hereinafter referred to as calibration) performed to maintain the color of an image constant for the custom sheet. Calibration is executed in the printing apparatus. First, the kinds of sheets handled in the present specification and the application range of correction data acquired through calibration will be described below. Note that color calibration is not limited to colors such as RGB but also includes cases where only black is used.

A “common calibration sheet” means such a sheet that the result (correction data or concentration value) of calibration performed by using the sheet can be commonly applied to another sheet with a different kind. Hereinafter, calibration executed by using a common calibration sheet is referred to as “common calibration”. In a case where a calibration result acquired by the common calibration is applied to another sheet, the color on the other sheet is also maintained constant.

An “individual calibration sheet” means such a sheet that the result (correction data or concentration value) of calibration performed by using the sheet can be applied only to the sheet but not applied to another sheet with a different kind. Hereinafter, calibration executed by using an individual calibration sheet is referred to as “individual calibration”. In a case where the individual calibration is executed by using an individual calibration sheet, the calibration result acquired by the common calibration is not applied to the individual calibration sheet. The result of the individual calibration executed by using the individual calibration sheet is applied. However, in a case where the individual calibration using an individual calibration sheet is not executed, the result of the common calibration is applied to the individual calibration sheet.

A sheet that is not suitable for either the common calibration or the individual calibration and cannot undergo calibration is a sheet for which calibration execution is impossible.

As described above, in a case where the common calibration is executed by using a common calibration sheet, the result acquired through the common calibration executed with the common calibration sheet is applied to another kind of sheet. In a case where a target sheet is a sheet on which the common calibration can be executed but calibration has not been executed, the common calibration result obtained by using another common calibration sheet is applied to the target sheet. In other words, in a case where the target sheet is a common calibration sheet, the result of calibration executed by using the target sheet is prioritized. In a case where calibration using the target sheet has not been executed, the result of calibration executed by using another common calibration sheet is applied to the target sheet.

Calibration cannot be executed on sheets with specific characteristics such as semi-transparent sheets, films, and sheets with surface irregularities (such as canvas). However, for such sheets with specific characteristics, it is possible to maintain a certain color by applying the result of the common calibration executed with a common calibration sheet. Thus, the common calibration result is applied to sheets on which calibration execution is impossible. Note that, in the present specification, a sheet refers not only to paper used in a typical printing apparatus but also broadly includes media such as vinyl, fabric, plastic film, metal plate, glass, ceramics, wood material, and leather.

In the control system according to the present embodiment, the user can register new sheet kind data as a “custom sheet” by referring sheet kind data of common calibration sheets and individual calibration sheets. Sheet kind data includes not only information such as sheet name, sheet ID, sheet category but also control parameters suitable for this sheet in the printing apparatus. The control parameters include, for example, head height, paper feed adjustment, and adsorption force. For a custom sheet, these parameters can be edited by the user. Sheet kind data will be described later.

In the present embodiment, one of parameters of sheet kind data is “calibration type”, which is an item that indicates the application range of correction data acquired through calibration. The control system according to the present embodiment allows the user to edit the “calibration type” in a case where edit target sheet kind data is a custom sheet. The “calibration type” is set to one of values “common” and “individual”. An information processing apparatus according to the present embodiment varies whether to allow a user to select “common” (first setting) in calibration type setting, depending on whether a predetermined condition is satisfied.

In a first embodiment, the user is allowed to set the value of “calibration type” to any of “common” or “individual” in a case where “calibration target value” is set in the sheet kind data of a custom sheet. On the other hand, the user is allowed to set the value of “calibration type” to only “individual” in a case where “calibration target value” is not set in the sheet kind data of a custom sheet. In a case where the calibration type is “common”, the sheet is handled as the above-described “common calibration sheet”. In other words, the common calibration is executed and the result of the calibration is applied not only to a calibration execution sheet but also to other sheets (common/individual calibration sheets) other than the calibration execution sheet. In a case where the calibration type is “individual”, the sheet is handled as the above-described “individual calibration sheet”. In other words, the individual calibration is executed and the result of the calibration is specific to sheets of the same kind as the calibration execution sheet and not applied to other sheets. Accordingly, even a custom sheet for which the application range of the calibration result was conventionally limited to the calibration execution sheet (second range) can be handled as a “common calibration sheet” and the application range of the calibration result is commonly usable for other sheets (first range) of different kinds.

### Hardware Configuration

The configuration of a control system including the information processing apparatus of the present disclosure will be described below.

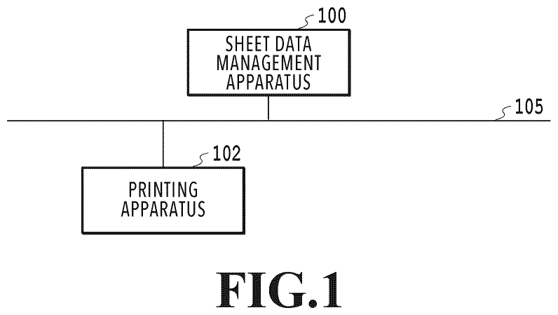

FIG. 1 is a diagram illustrating an exemplary configuration of the control system including the information processing apparatus of the present disclosure, which functions as a sheet data management apparatus 100.

As illustrated in FIG. 1, in the control system, the sheet data management apparatus 100 and a printing apparatus 102 are connected through a network 105 for communication. The printing apparatus 102 is, for example, an inkjet printer capable of large-format printing. Note that the printing apparatus 102 is not limited to an inkjet printer capable of large-format printing but may be a printing apparatus of another kind. The printing apparatus 102 may be, for example, an inkjet printer for printing on a normal-size sheet. Printing material is not limited to ink but the present disclosure is applicable to printing apparatuses of various printing schemes, including thermal printers (such as sublimation and heat transfer types), dot impact printers, LED printers, laser printers, and other electrophotographic schemes. The printing apparatus 102 may be a multi-function peripheral (MFP) that has, in addition to a printing function, copying, transmitting, faxing, storing functions, and other similar functions.

The printing apparatus 102 has a calibration function in addition to a printing function. With the calibration function, the printing apparatus 102 executes calibration corresponding to the kind of a sheet. Specifically, the printing apparatus 102 holds sheet kind data that is set with a plurality of parameter values corresponding to the sheet kind, including “calibration target value” and “calibration type”. The printing apparatus 102 executes calibration in accordance with a calibration type based on the calibration target value. Functions of the printing apparatus 102 will be described later in detail.

The sheet data management apparatus 100 is an information processing apparatus that performs management of sheet data held in the printing apparatus 102 and is configured by a computer such as a PC. The sheet data held in the printing apparatus 102 includes sheet kind data corresponding to each of a plurality of sheet kinds and is managed by the sheet data management apparatus 100. For example, the sheet data management apparatus 100 can add and delete sheet data to and from the printing apparatus 102 for each sheet kind. The sheet data management apparatus 100 has an edit function for the user to edit sheet data.

When performing sheet data edit, the sheet data management apparatus 100 obtains sheet data held in the printing apparatus 102 executes edit processing on the obtained sheet data and updates the sheet data. The updated sheet data is distributed from the sheet data management apparatus 100 to the printing apparatus 102, and sheet data in the printing apparatus 102 is updated. Functions of the sheet data management apparatus 100 will be described later in detail.

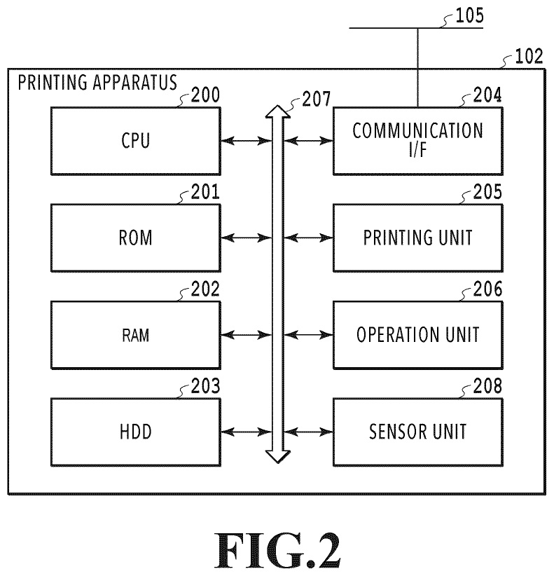

FIG. 2 is a block diagram illustrating an exemplary hardware configuration of the printing apparatus 102. As illustrated in FIG. 2, the printing apparatus 102 includes a CPU 200, a ROM 201, a RAM 202, a HDD 203, a communication I/F 204, a printing unit 205, an operation unit 206, and a sensor unit 208.

The CPU 200 collectively controls each component of the printing apparatus 102. The CPU 200 calls a control program stored in a computer program ROM of the ROM 201, a control program stored in the HDD (hard disk) 203, or the like, loads the control program onto the RAM 202, and executes processing based on the computer program. The CPU 200 prints a color patch with the printing unit 205 during calibration execution and reads the concentration value of the color patch with the sensor unit 208. The CPU 200 produces a look-up table for correcting the read concentration value to a target concentration value (calibration target value) and stores the look-up table in the HDD 203 for each sheet kind. Hereinafter, the look-up table is referred to as correction data or a calibration result.

In this case, the CPU 200 stores the correction data in the HDD 203 in association with the application range of the correction data. In a case where the “calibration type” of the calibration execution sheet is “individual”, the CPU 200 stores the application range of the correction data as specific to the execution sheet. In a case where the “calibration type” of the calibration execution sheet is “common”, the CPU 200 stores the application range of the correction data as common to sheets, that is, applicable to all sheets for which calibration has not been executed.

In a case of executing printing on a sheet of the same kind as the calibration execution sheet, the CPU 200 obtains the stored correction data from the HDD 203 and applies the correction data to printing data by correcting. The CPU 200 outputs, as output information to the printing unit 205, an image signal generated from the above-described printing data corrected by using the correction data.

Note that the above description is made on the example in which correction data acquired through calibration is stored in the HDD 203 in association with its application range, but a concentration value acquired through calibration may be stored in the HDD 203 in association with the application range. In this case, at printing, the CPU 200 obtains the concentration value from the HDD 203, produces a look-up table for correction to a target concentration value (calibration target value), and applies the correction to printing data.

The CPU 200 can perform communication processing with the sheet data management apparatus 100 through the communication I/F 204 and transmit information in the printing apparatus 102 to the sheet data management apparatus 100.

The ROM 201 is a non-transitory storage region and holds computer programs, operating systems (OS), and the like according to the present embodiment. The RAM 202 is a transitory or non-transitory memory and functions as, for example, a main memory or a work area of the CPU 200. The memory capacity of the RAM 202 can be extended by an option RAM connected to a non-illustrated expansion port. Note that the RAM 202 is also used as an output information loading region, an environment data storage region, or the like in a case where printing is executed in accordance with a printing job. The HDD (hard disk) 203 is a storage apparatus and stores, for example, font data, sheet data, and printing jobs. Note that the HDD 203 may be replaced with a storage apparatus of another kind such as an SSD.

The operation unit 206 includes an input unit including a touch panel, various keys, buttons, and the like and also includes a display unit such as a display. The user can input an operation to the printing apparatus 102 through the operation unit 206, and various kinds of information indicating the state of the printing apparatus 102, and the like can be displayed on the operation unit 206. The communication I/F 204 is an interface for performing data transmission and reception with an external apparatus. The external apparatus includes the sheet data management apparatus 100.

The printing unit 205 includes a printing head that discharges ink, a tank that supplies ink to the printing head, a feeding unit that supplies sheets, and a conveyance unit that conveys sheets. The printing unit 205 forms an image by discharging ink to a sheet conveyed to a position facing the head in accordance with printing data supplied from the CPU 200. After the image is formed thereon, the sheet is subjected to processes such as drying, curing, and cooling while being conveyed along a conveyance path, and then is discharged from a sheet discharge port.

The sensor unit 208 includes various sensors such as a color measurement sensor that detects the concentration value of a color patch during calibration execution, a sensor that measures a reflectance for measuring the glossiness of a sheet, a sensor that detects the amount of remaining ink in the tank, and a sensor for detecting the conveyance position of a sheet. Detection signals detected by the sensor unit 208 are input to the CPU 200.

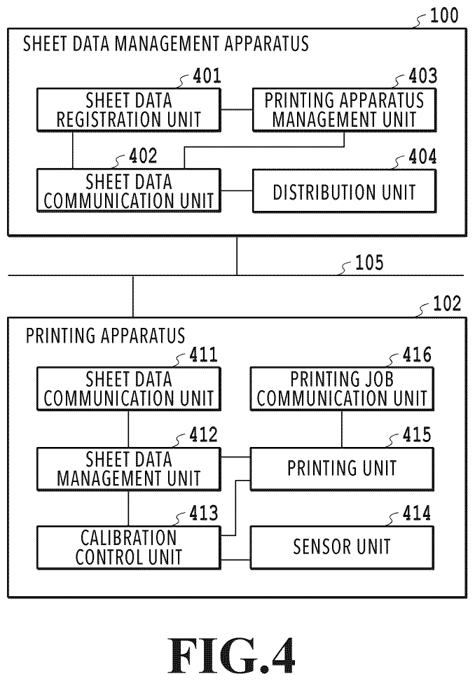

In the printing apparatus 102 according to the present embodiment, the CPU 200 controls, through a system bus 207, each component connected to the system bus 207, unless otherwise stated. Each component included in the functional configuration of the printing apparatus 102 illustrated in FIG. 4 to be described later may be configured as a program module. In this case, for example, each program module is stored in the ROM 201 or the HDD 203. Each program module read onto the RAM 202 by the CPU 200 is executed by the CPU 200.

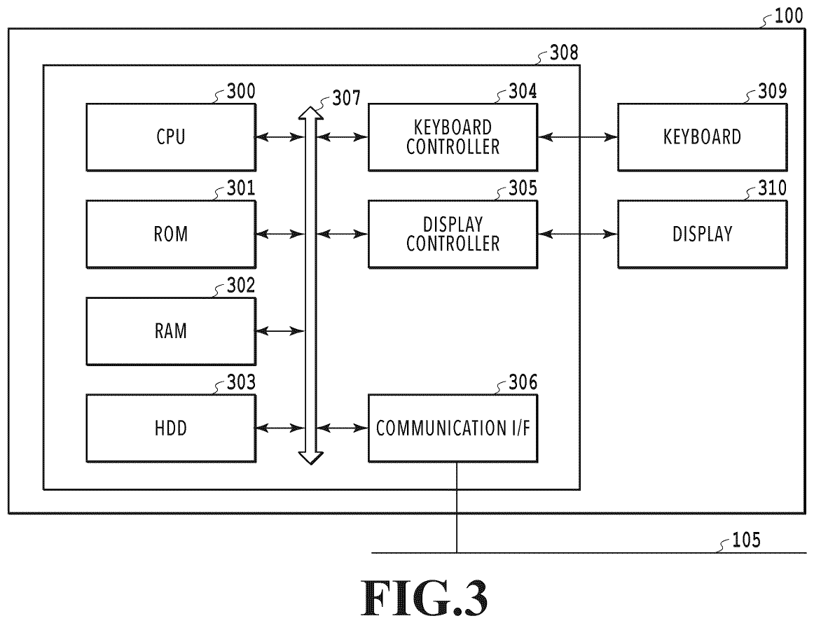

FIG. 3 is a block diagram illustrating the configuration of a computer used as the sheet data management apparatus 100. Note that the configuration of the sheet data management apparatus 100 is not limited to the example illustrated in FIG. 3 but may be a different configuration. The computer includes a CPU 300, a ROM 301, a RAM 302, a HDD 303, a keyboard controller 304, a display controller 305, and a communication I/F 306 in an inside 308. Each component inside is connected to the CPU 300 through a system bus 307.

The CPU 300 reads various computer programs such as control programs, system programs, and application programs from the ROM 301 or the HDD 303 onto the RAM 302. The CPU 300 executes the various computer programs read onto the RAM 302 and performs various kinds of data processing. The CPU 300 may be a dedicated circuit such as an ASIC. The CPU 300 is an example of a hardware circuit or a hardware processor.

In the present embodiment, the CPU 300 of the sheet data management apparatus 100 executes processing for managing and editing sheet data used in the printing apparatus 102. In the processing for managing and editing sheet data, the CPU 300 obtains sheet data held in the printing apparatus 102 through the communication I/F 306 and loads the sheet data onto the RAM 302. The CPU 300 performs various processing including edit on the sheet data loaded onto the RAM 302 and transmits (distributes) the sheet data to the printing apparatus 102 through the communication I/F 306 again. The sheet data edit processing will be described later in detail.

The ROM 301, the RAM 302, the HDD 303, and the communication I/F 306 are the same as the ROM 201, the RAM 202, the HDD 203, and the communication I/F 204 described above.

The keyboard controller 304 controls inputting from a keyboard 309, a non-illustrated pointing device, or the like. The display controller 305 controls displaying on a display 310.

In the present embodiment, the CPU 300 controls, through the system bus 307, each component connected to the system bus 307 unless otherwise stated. Each functional block of the sheet data management apparatus 100 illustrated in FIG. 4 to be described later may be configured as a program module. In this case, for example, each program module is stored in the ROM 301 or the HDD 303. Each program module read onto the RAM 302 by the CPU 300 is executed by the CPU 300 to achieve its function.

### Functional Configuration

FIG. 4 is a block diagram illustrating the functional configuration of the control system according to the present embodiment. As described above, the sheet data management apparatus 100 and the printing apparatus 102 in the control system are connected through the network 105 for communication. Hereinafter, the functions of the sheet data management apparatus 100 and the printing apparatus 102 will be described below in the stated order of the apparatuses.

First, the functional configuration of the sheet data management apparatus 100 will be described below. As illustrated in FIG. 4, the sheet data management apparatus 100 includes a sheet data registration unit 401, a sheet data communication unit 402, a printing apparatus management unit 403, and a distribution unit 404.

A sheet data registration unit 401 has a function to edit sheet data. The sheet data edit function includes, for example, addition, deletion, new production, and change of sheet data. Addition and new production of sheet data are referred to as registration of sheet data in the present specification.

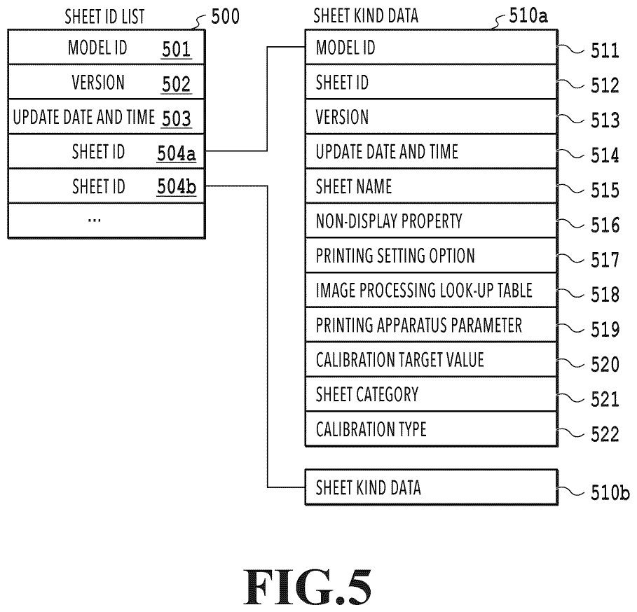

With the sheet data addition function, the sheet data registration unit 401 obtains sheet kind data corresponding to various sheet kinds distributed by a Web server through the Internet and adds the obtained sheet kind data to the printing apparatus 102. Note that the sheet data registration unit 401 may obtain sheet kind data through a storage medium such as a CD-ROM, not through the Internet. Sheet data and sheet kind data will be described later (FIG. 5).

With the sheet data deletion function, the sheet data registration unit 401 deletes sheet data registered to a sheet data management unit 412 of the printing apparatus 102.

With the sheet data new production function, the sheet data registration unit 401 receives selection of reference sheet kind data from among sheet kind data obtained by the above-described addition function and produces new sheet kind data based on the selected sheet kind data. In this manner, sheet kind data produced by the user is referred to as a custom sheet. In a case where printing is executed by using an optional sheet of a kind different from those of sheets already added to sheet data, the user produces a custom sheet by using the sheet data new production function. The reference sheet kind data (hereinafter referred to as a reference sheet) of a custom sheet is preferably a sheet with similar paper quality, paper weight, paper thickness, and the like.

In a case where a custom sheet is newly produced, the sheet data registration unit 401 copies sheet kind data 510 of the reference sheet and then changes partial data through a procedure described below for production.
(1) First, the sheet data registration unit 401 newly produces a sheet ID that is uniquely identifiable in sheet data, and changes the value of a sheet ID 512 in the sheet kind data 510 of custom sheet to the newly produced sheet ID.
(2) Subsequently, the sheet data registration unit 401 changes the value of a sheet name 515 in the sheet kind data 510. The sheet data registration unit 401 displays, for example, a sheet name setting UI (user interface) on the display 310 and sets a sheet name designated by the user through the UI to the sheet name 515 in the copied sheet kind data 510.
(3) Further, the sheet data registration unit 401 changes the value of a sheet category 521 in the sheet kind data 510 to a value “custom” indicating a custom sheet.
(4) In addition, since a custom sheet does not have characteristics completely identical to those of the reference sheet, the sheet data registration unit 401 deletes the value of a calibration target value 520 in the sheet kind data 510 and sets “not produced” to a calibration type 522.

The sheet data registration unit 401 adds the sheet kind data 510 provided with the above-described change to the sheet data and adds the sheet ID newly produced through the above-described process (1) to a sheet ID list 500. Accordingly, a template of the sheet kind data 510 of custom sheet is produced. The sheet data registration unit 401 receives edit on the template by a user operation.

In custom sheet edit processing, the sheet data registration unit 401 receives adjustments made by the user to printing apparatus parameters 519 such as a sheet feed amount and an ink deposition amount. The sheet data registration unit 401 also receives setting of a new calibration target value for a custom sheet. When an operation to produce the calibration target value 520 of a custom sheet is performed by the user through a calibration target value setting UI, the sheet data registration unit 401 sets a new value to the calibration target value 520 of a custom sheet. Thereafter, the sheet data registration unit 401 sets the value of the calibration type 522.

In the present disclosure, the sheet data registration unit 401 determines whether a target sheet is a custom sheet that allows the user to edit information related to the sheet, and sets the calibration type 522 to either “common” or “individual” in a case where the target sheet is a custom sheet. In the first embodiment, the calibration type 522 of custom sheet is set to either “common” or “individual” in accordance with a designation operation by the user. The calibration type 522 is a parameter for determining the application range of a calibration result. In a case where the calibration type 522 is set to “common”, the common calibration is executed and the result of the calibration is applied not only to the calibration execution sheet but also to other kinds of sheet different from the calibration execution sheet. In a case where the calibration type 522 is set to “individual”, the individual calibration is executed and the result of the calibration is specific to the same kind of sheet as the calibration execution sheet and not applied to other kinds of sheet.

The sheet data registration unit 401 receives setting of the calibration type 522 of custom sheet in a case where conditions described below are satisfied. The conditions in the first embodiment are that at least a target sheet is a sheet with which the color calibration is executable and a value is set to the calibration target value 520 in the sheet kind data 510 of custom sheet. In the first embodiment, whether the target sheet is a sheet the calibration result of which is applicable to other kinds of sheet different from the calibration execution sheet is determined based on determination and an operation by the user.

In a case where the above-described conditions are satisfied, the sheet data registration unit 401 allows the user to select any one of “common” and “individual” as the calibration type 522. In a case where the above-described conditions are not satisfied, the sheet data registration unit 401 allows the user to select only “individual” as the calibration type 522 and does not receive selection of “common”.

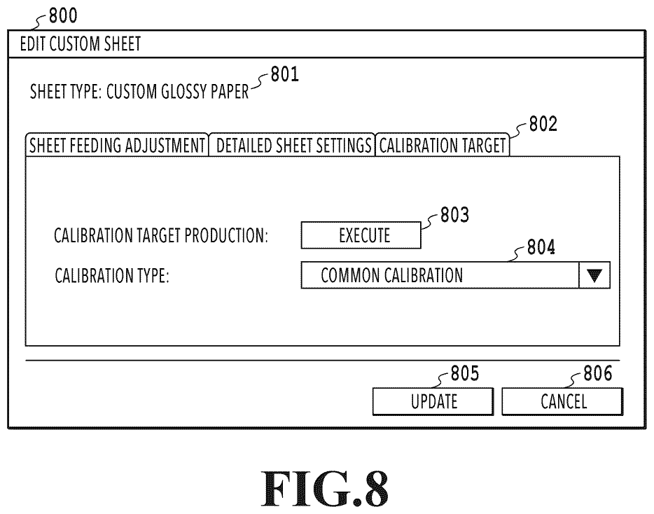

The sheet data registration unit 401 preferably provides a UI 800 for setting the calibration type 522 of custom sheet. In a case where the above-described conditions are satisfied, the sheet data registration unit 401 sets the display state of the UI 800 to a display state (first display state) in which any one of “common calibration” and “individual calibration” can be selected. In a case where the above-described conditions are not satisfied, the display state of the UI 800 is set to a display state (second display state) in which only “individual calibration” can be selected but “common calibration” cannot be selected. A specific example of the UI 800 will be described later (FIG. 8).

With the sheet data edit function, the sheet data registration unit 401 receives, also for an existing custom sheet, change of the calibration type 522 by the user. For example, the calibration type 522 can be changed to “common” for a custom sheet for which the calibration type 522 is set to “individual”.

In addition, the sheet data registration unit 401 receives settings of a custom sheet and sheet kind data other than a custom sheet, such as change of the arrangement order of sheet names on a sheet list displayed on the printing apparatus 102, and switching of display/non-display of sheet names.

The sheet data communication unit 402 has functions to receive sheet data held in the sheet data management apparatus 100 and the printing apparatus 102 and transmit sheet data to the printing apparatus 102 through the network 105. The sheet data communication unit 402 performs data transmission and reception with the printing apparatus 102 by using, for example, the HTTP protocol. Note that the present disclosure is not limited to the HTTP protocol, but any protocol that allows data transmission and reception between apparatuses may be used.

The printing apparatus management unit 403 manages the printing apparatus 102 connected to the sheet data management apparatus 100 for communication. For example, the printing apparatus management unit 403 transmits broadcast packets to the network 105 and queries one or a plurality of printing apparatuses 102, 102, and so on that have responded as to whether a predetermined function exists. In a case where the predetermined function exists, the printing apparatus management unit 403 registers identification information (such as apparatus ID) of any printing apparatus 102 to non-illustrated printing apparatus list data. The predetermined function is, for example, a sheet data management function or a calibration function. For example, the HTTP protocol is used when the printing apparatus 102 is queried for the predetermined function, but the present disclosure not limited to the HTTP protocol and any protocol with which information can be exchanged between apparatuses may be used.

The distribution unit 404 distributes sheet data that is set by the sheet data registration unit 401 through the sheet data communication unit 402 to any printing apparatus 102 managed by the printing apparatus management unit 403.

The functional configuration of the printing apparatus 102 will be described next. As illustrated in FIG. 4, the printing apparatus 102 includes a sheet data communication unit 411, the sheet data management unit 412, a calibration control unit 413, a sensor unit 414, a printing unit 415, and a printing job communication unit 416.

The sheet data communication unit 411 transmits and receives sheet data managed by the sheet data management unit 412 to and from the sheet data management apparatus 100 through the network 105.

The sheet data management unit 412 holds sheet data illustrated in FIG. 5. The sheet data held by the sheet data management unit 412 is displayed on the operation unit 206 of the printing apparatus 102 and used by the calibration control unit 413 and the printing unit 415.

The calibration control unit 413 executes calibration using an optional sheet. The calibration control unit 413 prints a color patch by using sheet kind data corresponding to a sheet used for calibration among the sheet data held by the sheet data management unit 412. Then, the calibration control unit 413 obtains the concentration value of the patch printing result, produces a look-up table (correction data) for correcting the concentration value to a target concentration value (calibration target value), and stores the look-up table as a calibration result in the HDD 203. At printing, the correction data is applied to printing data. When storing the calibration result in the HDD 203, the calibration control unit 413 associates the calibration result with the application range (the first range as common to sheets or the second range as specific to the execution sheet) of the calibration result.

The sensor unit 414 measures the concentration value of a printing result in a case where calibration is executed and in a case where the calibration target value of a custom sheet is produced.

The printing job communication unit 416 receives printing job data transmitted from a printing job generation apparatus (not illustrated) through the network 105.

The printing unit 415 performs printing based on the printing job data received by the printing job communication unit 416. The printing unit 415 corrects printing data included in the printing job data by using the above-described correction data and prints the corrected printing data by applying sheet kind data held by the sheet data management unit 412.

### Sheet Data

FIG. 5 is a diagram illustrating the configuration of sheet data. The sheet data is held by the sheet data management unit 412 of the printing apparatus 102. The sheet data can be edited by the sheet data registration unit 401 of the sheet data management apparatus 100. As illustrated in FIG. 5, the sheet data includes the sheet ID list 500 and one kind or more of sheet kind data 510a, 510b, and so on.

The sheet kind data 510a, 510b, and so on are data stored with information related to different kinds of sheets, respectively. In the following description, the reference sign “510” is attached in a case where the individual sheet kind data 510a, 510b, and so on are not distinguished. The sheet kind data 510 includes information such as a model ID 511, the sheet ID 512, a version 513, an update date and time 514, the sheet name 515, a non-display property 516, a printing setting option 517, an image processing look-up table 518, the printing apparatus parameters 519, the calibration target value 520, the sheet category 521, and the calibration type 522.

The sheet ID list 500 is data for managing the plurality of sheet kind data 510a, 510b, and so on and includes information such as a model ID 501, a version 502, an update date and time 503, and sheet IDs 504a, 504b, and so on.

The model ID 501 is information for identifying the model of the printing apparatus 102. When having received the sheet ID list 500 from the sheet data management apparatus 100, the printing apparatus 102 determines whether the received list is the sheet ID list 500 that matches the model ID of the printing apparatus 102. In a case of having received the sheet ID list 500 with a different model ID, the printing apparatus 102 discards the received sheet data. Thereafter, for example, the operation unit 206 displays that irrelevant sheet data has been received.

The version 502 indicates the version of data format of the sheet ID list 500. The printing apparatus 102 determines whether the version 502 written in the sheet ID list 500 transferred from the sheet data management apparatus 100 matches a version written in a sheet ID list already existing in the printing apparatus 102. In a case where the version 502 of the received sheet ID list 500 is different from versions supported by the printing apparatus 102, the printing apparatus 102 discards the received sheet data. Thereafter, for example, the operation unit 206 displays that sheet data of a version other than supported versions has been received. Note that the version 502 of the sheet ID list 500 is the version of data format and thus is not changed by addition and edit of the sheet kind data 510.

The update date and time 503 indicates the date and time when the sheet ID list 500 is updated.

The sheet IDs 504a, 504b, and so on are the sheet IDs 512 of the at least one or more sheet kind data 510a, 510b, and so on included in sheet data. The arrangement order of sheet names on a sheet list displayed on the operation unit 206 of the printing apparatus 102 is controlled based on the order in which the sheet ID list 500 holds the two or more sheet IDs 504a, 504b, and so on.

The contents of the sheet kind data 510 will be described below.

The model ID 511 is set to the same value as the model ID 501 of the sheet ID list 500. When having received the sheet kind data 510 from the sheet data management apparatus 100, the printing apparatus 102 determines whether the sheet kind data 510 matches the model ID of the printing apparatus 102. In a case of having received the sheet kind data 510 with a different model ID, the printing apparatus 102 discards the received sheet data. Thereafter, for example, the operation unit 206 displays that irrelevant sheet data has been received.

The sheet ID 512 is the same value as any of the sheet IDs 504 stored in the sheet ID list 500.

The version 513 indicates the version of data format of the sheet kind data 510. The printing apparatus 102 determines whether the version 513 of the sheet kind data 510 received from the sheet data management apparatus 100 is equal to or later than the version of sheet kind data already existing in the printing apparatus 102. In a case where the version 513 of the received sheet kind data 510 is older, the received sheet kind data 510 is discarded. This processing is processing for preventing downgrade to sheet kind data of an older version. Thereafter, for example, the operation unit 206 displays that sheet data of an irrelevant version has been received.

The update date and time 514 indicates the date and time when the sheet kind data is updated.

The sheet name 515 is the sheet name of the sheet kind data 510 and includes the sheet name in at least one language or more.

The non-display property 516 is set to a flag indicating whether to display the sheet name 515 on the sheet list displayed on the operation unit 206 of the printing apparatus 102. In a case where the non-display property 516 is set to a flag indicating “not displayed”, the sheet name 515 is not displayed on the sheet list on the operation unit 206.

The printing setting option 517 indicates various kinds of printing setting information that can be used with the sheet kind data 510. For example, information such as picture and CAD drawing, which can be set as a printing purpose, is included.

The image processing look-up table 518 is various kinds of image processing tables used at printing. For example, a table for breakdown by ink color is included. The image processing look-up table is used at printing and thus also used at patch printing during calibration execution.

The printing apparatus parameters 519 are mechanical parameters of the printing unit 205 of the printing apparatus 102 and include, for example, data of the head height and the sheet feed amount.

The calibration target value 520 is target data when the printing apparatus 102 executes calibration with the sheet, and is set to the concentration value corresponding to the ink deposition amount (number of dots) for each ink color. Note that the calibration target value 520 is deleted from a newly produced custom sheet template (sheet kind data copied from the reference sheet) and newly produced in accordance with an operation by the user in custom sheet editing. When sheet data in the printing apparatus 102 is updated to sheet data including the sheet kind data 510 with which the calibration target value 520 is produced, calibration of a custom sheet becomes executable.

The sheet category 521 is information indicating a similar sheet type group and is, for example, standard paper, coated paper, or photo paper. A custom sheet is categorized as “custom”.

The calibration type 522 is information indicating the application range of a calibration result. The calibration type 522 is set to “common” in a case where the application range of the calibration result is commonly applicable to other sheets of kinds different from a target sheet (sheet with which calibration is executed) (first range). The calibration type 522 is set to “individual” in a case where the calibration result cannot be applied to other sheets of kinds different from the target sheet (second range). The calibration type 522 of custom sheet has been conventionally limited to “individual”, but in the present embodiment, “common” can be set for a custom sheet based on determination by the user. This makes it possible to perform printing with the result of calibration of a custom sheet applied to other kinds of sheets. A method of setting the application range of the calibration result will be described later.

### Entire Process of Sheet Data Edit Function

The sheet data edit processing executed by the sheet data management apparatus 100 will be described below.

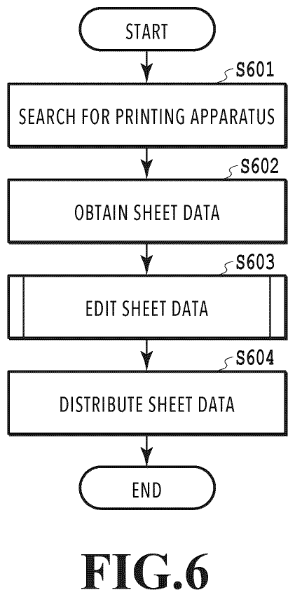

FIG. 6 is a flowchart illustrating the entire process of the sheet data edit processing. The processing illustrated in the present flowchart is written in a computer program stored in the ROM 301 or the HDD of the sheet data management apparatus 100 303. The computer program is called by the CPU 300, loaded onto the RAM 302, and executed by the CPU 300. When start of sheet data edit is instructed by the user, the CPU 300 starts the present processing in the sheet data management apparatus 100. In the following description, a symbol “S” means a step.

At S601, the CPU 300 of the sheet data management apparatus 100 searches for any printing apparatus 102 existing in the control system illustrated in FIG. 1.

At S602, the CPU 300 obtains sheet data held by the searched printing apparatus 102.

At S603, the CPU 300 executes edit processing of the obtained sheet data. In the edit processing at S603, the CPU 300 executes, for example, custom sheet edit processing. In the custom sheet edit processing, setting of the calibration type 522 of a custom sheet by the user is received. This processing will be described later in detail.

At S604, the CPU 300 distributes the sheet ID list 500 and the sheet kind data 510 subjected to the edit to the printing apparatus 102 at the obtainment source, and ends the present flowchart.

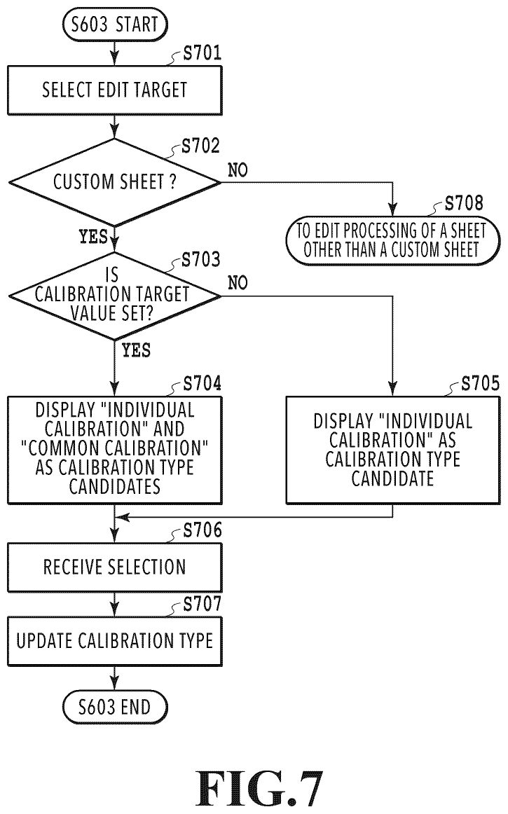

Calibration type setting processing in the custom sheet edit processing executed at S603 will be described below. FIG. 7 is a flowchart illustrating processing of setting the calibration type of a custom sheet in the sheet data edit processing. The processing illustrated in the present flowchart is executed by the sheet data registration unit 401 (CPU 300) of the sheet data management apparatus 100.

At S701, the CPU 300 displays a screen on which a sheet list is displayed, and receives selection of an edit target sheet by the user. The CPU 300 refers to the sheet kind data 510 of the edit target sheet selected by the user.

At S702, the CPU 300 determines whether the sheet category 521 of the edit target sheet kind data 510 is “custom sheet”. In a case where the sheet category 521 is “custom sheet”, the CPU proceeds to S703, or in a case where the sheet category 521 is not “custom sheet”, the CPU proceeds to S708 and transitions to edit processing of a sheet other than a custom sheet. In the edit processing of a sheet other than a custom sheet, sheet names, the arrangement order of sheets in the sheet list, and the like can be edited.

At S703, the CPU 300 determines whether a value is set to the calibration target value 520 of the edit target sheet kind data 510. The CPU proceeds to S704 in a case where a value is set to the calibration target value 520, or proceeds to S705 in a case where no value is set to the calibration target value 520.

At S704, the CPU 300 allows the value of the calibration type 522 of the edit target sheet kind data 510 to be set to either “common” or “individual”. Specifically, the CPU 300 displays the UI 800 for setting the calibration type 522.

### UI for Setting Calibration Type

FIG. 8 is a diagram illustrating an example of the UI 800 for setting the calibration type. In the example illustrated in FIG. 8, a calibration type setting field 804 is provided on a “calibration target” tab 802 on a custom sheet edit screen (the UI 800). Calibration type candidates are displayed in the setting field 804, for example, in a pull-down list format. A calibration target sheet kind (sheet name) 801 is displayed as, for example, “custom glossy paper”. In addition, a “execution” button 803 that is operated by the user to produce a calibration target, and a “cancel” 804 that is operated to return to the previous screen are displayed.

At S704, the CPU 300 displays both “individual calibration” and “common calibration” in the pull-down list of the setting field 804 of the UI 800. Accordingly, the user can select and set either “individual” or “common” as the calibration type 522 of a custom sheet selected as the edit target at S701.

Description of FIG. 7 continues.

The CPU proceeds to S705 in a case where the sheet category 521 of the sheet kind data 510 is “custom sheet” but the calibration target value 520 is not set.

At S705, the CPU 300 allows the value of the calibration type 522 of the sheet kind data 510 to be set only to “individual”. Specifically, the CPU 300 displays the UI 800 for setting the calibration type 522 and displays only “individual calibration” as a selection candidate in the pull-down list of the setting field 804. Accordingly, the user can set, as “individual” but not as “common”, the calibration type 522 of the custom sheet selected as the edit target at S701.

At S706, the CPU 300 receives selection of a calibration type from the pull-down list of the setting field 804 of the UI 800. In a case where an update button 805 of the UI 800 is operated while the calibration type is selected, the CPU proceeds to S707. In a case where a cancel button 806 is operated, the CPU returns to the previous screen (sheet list display screen).

At S707, the CPU 300 updates the calibration type 522 of the sheet kind data 510 in accordance with the setting selected by the user and ends the present flowchart.

Through the above-described processing, the calibration type 522 of the custom sheet is set to either “common” or “individual” based on an operation by the user. In a case where the calibration type 522 is “common”, the result of calibration performed by using the custom sheet as the edit target is commonly applicable to other sheets. On the other hand, in a case where the calibration type 522 is “individual”, the result of calibration performed by using the custom sheet as the edit target is not applied to other sheets but is applied specifically to the custom sheet. In this manner, for the custom sheet as the edit target, the application range of the calibration result is set based on determination by the user.

### Calibration Processing

Calibration processing executed by the printing apparatus 102 will be described next.

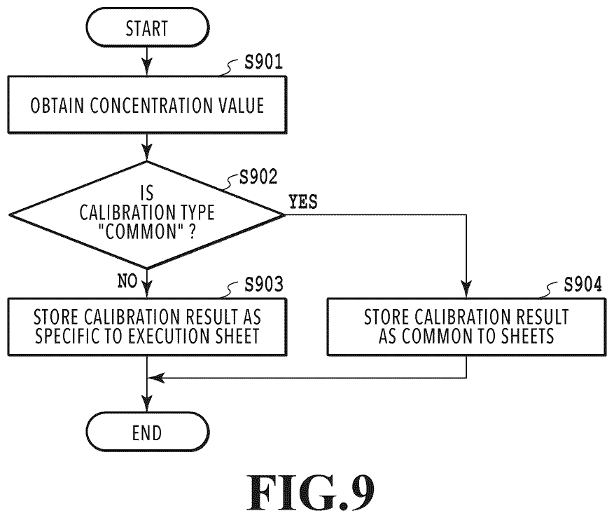

FIG. 9 is a flowchart illustrating the process of the calibration processing. The processing illustrated in the present flowchart is written in a computer program stored in the ROM 201 or the HDD 203 of the printing apparatus 102. The computer program is called by the CPU 200, loaded onto the RAM 202, and executed by the CPU 200. Sheet data including the sheet kind data 510 of a custom sheet, which is produced in the sheet data management apparatus 100 is distributed to the printing apparatus 102 and stored in the HDD 203 of the printing apparatus 102. The CPU 200 starts the present processing when a calibration execution instruction is input by the user through the operation unit 206 of the printing apparatus 102. Note that a calibration target sheet is a custom sheet. The calibration type 522 of the sheet kind data 510 is set to either “individual” or “common” before the calibration processing illustrated in the present flowchart is started.

At S901, the calibration control unit 413 (CPU 200) prints a color patch and obtains the concentration value. Specifically, the CPU 202 instructs the printing unit 205 to print the patch. After the patch is printed by the printing unit 205, the concentration value of the printing result is detected by the sensor unit 208 and input to the CPU 200.

At S902, the CPU 200 determines whether the calibration type 522 of the sheet kind data 510 used during calibration execution is “common”. In a case where the calibration type 522 is not “common”, the CPU proceeds to S903.

At S903, the CPU 200 stores, in the HDD 203, the calibration result as specific to the sheet with which the calibration is executed (second range). The calibration result is the concentration value obtained at S901 or a look-up table (correction data) determined based on the concentration value and the calibration target value.

In a case where the calibration type 522 is “common” in the determination at S902, the CPU proceeds to S904. At S904, the CPU 200 stores the calibration result as common to sheets (first range) in the HDD 203 and ends the present flowchart.

Note that correction data is stored as the calibration result in the HDD 203, but the concentration value may be stored. In this case, at printing execution, a look-up table (correction data) determined based on the concentration value and the calibration target value is produced and applied to printing data. Moreover, although the calibration result is stored in the HDD 203 of the printing apparatus 102 in the above-described example, the storage destination is not limited to the HDD 203 but may be any storage region where stored data is held and can be obtained at printing execution.

When executing printing of a printing job received by the printing job communication unit 416, the CPU 200 applies the above-described calibration result to printing data. Accordingly, the color calibration achieves color matching.

As described above, the printing apparatus 102 can execute calibration based on the calibration type 522 included in the sheet kind data 510, which is set by the user in the sheet data management apparatus 100. Specifically, even for a custom sheet, the application range of the calibration result can be held as information common to sheets (first range) in a case where the calibration type 522 is set to “common”.

Thus, in a case where a sheet is determined by the user to be suitable for the common calibration, the user can edit the value of the calibration type 522 of the sheet kind data 510, making it possible to use the sheet as a common calibration sheet. In this manner, even for a custom sheet, the result of the color calibration can be commonly applied to other sheets, thereby broadening the usage form of sheet data and improving convenience.

Note that the functions (such as the sheet data registration unit 401 and the sheet data communication unit 402) of the sheet data management apparatus 100 illustrated in FIG. 4 may be implemented at the printing apparatus 102. Moreover, UI display examples and the data configuration of sheet kind data are exemplary and changeable as appropriate.

In the above-described embodiment, the calibration type 522 can be set to “individual” in a case where no value is set to the calibration target value 520, but reception of change to the calibration type may be disabled due to a non-calibratable state. Specifically, the pull-down list of the setting field 804 of the UI 800 may be grayed out or not displayed, and the calibration type 522 may remain as “not set”, which is the initial value at template production of a custom sheet.

In the example described above in the embodiment, the user sets the application range (calibration type 522) of the calibration result before calibration processing is executed, but the present disclosure is not limited thereto. The user may set the application range (the calibration type 522) of the calibration result by editing the sheet kind data 510 after calibration execution. In this case, the CPU 300 updates, with edited information, sheet data (sheet kind data) stored in the HDD 203 of the printing apparatus 102. The CPU 300 also updates, with edited information, the application range of the calibration result (correction value data) stored in the HDD 203.

### Second Embodiment

In the first embodiment, the calibration type 522 of an optional custom sheet for which the calibration target value 520 is set in the sheet kind data 510 can be changed to “common” based on determination by the user. In addition, a condition for the sheet data registration unit 401 to receive setting of the calibration type 522 of a custom sheet is that a target sheet is a calibration executable sheet and the calibration target value 520 is set.

In a second embodiment, a predetermined condition for property information of a custom sheet is further determined and the calibration type 522 is changeable to “common” based on the result of the determination. In other words, in the second embodiment, a sheet the calibration type 522 of which is changeable to “common” is restricted based on the property information of the sheet.

The second embodiment will be described below with reference to the accompanying drawings.

Note that the hardware and functional configurations of the control system, the printing apparatus 102, and the sheet data management apparatus 100 in the second embodiment are the same as in the first embodiment, and thus identical parts are denoted by the same reference sign, and duplicate description thereof is omitted.

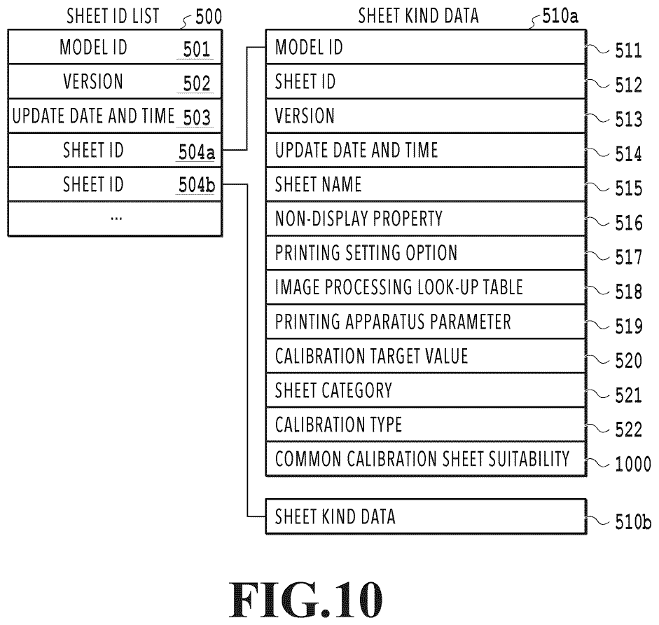

FIG. 10 is a diagram illustrating exemplary sheet data in the second embodiment. As in the first embodiment, sheet data is held by the sheet data management unit 412 of the printing apparatus 102 and can be edited by the sheet data registration unit 401 of the sheet data management apparatus 100. Difference from sheet data according to the first embodiment is that the sheet kind data 510 includes information of common calibration sheet suitability 1000.

The common calibration sheet suitability 1000 is information indicating whether a custom sheet is usable as a common calibration sheet in a case where the custom sheet is a target sheet. Information indicating “yes” is set in a case where the target custom sheet is usable as a common calibration sheet. Information indicating “no” is set in a case where the target custom sheet is not usable as a common calibration sheet.

In the second embodiment, the common calibration sheet suitability 1000 is set in the sheet kind data 510 of the reference sheet of a custom sheet in advance. As described above, the CPU 300 copies the sheet kind data 510 of the reference sheet at new production of a custom sheet. Thus, the common calibration sheet suitability 1000 of a custom sheet is set to the value of the common calibration sheet suitability 1000 set in the sheet kind data 510 of the reference sheet.

In a case of glossy paper or semi-glossy paper that is difficult to cockle even if it is a third-party sheet, the common calibration sheet suitability 1000 is set to “yes” in advance. Accordingly, the common calibration sheet suitability 1000 in accordance with the reference sheet is set for a custom sheet as well.

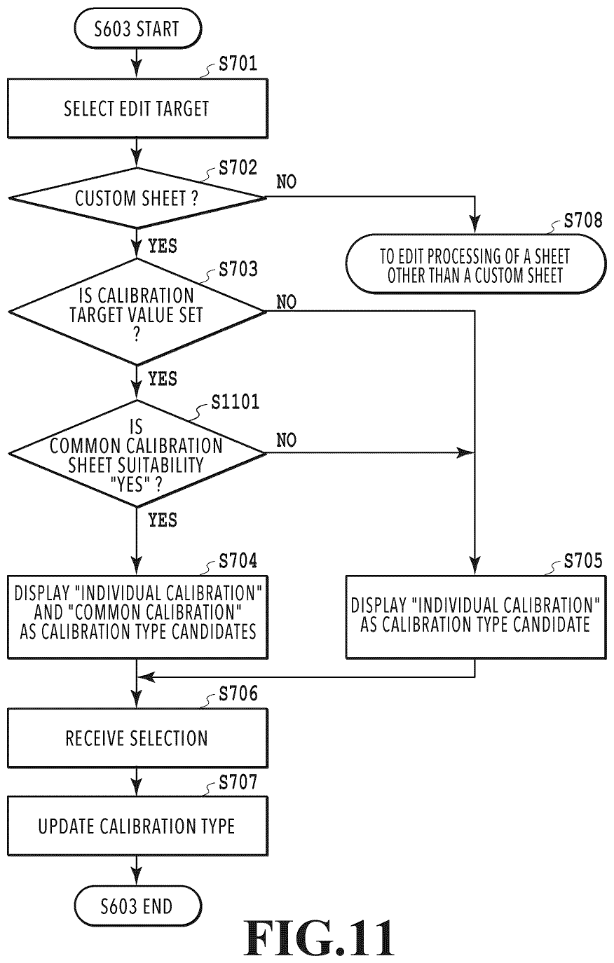

FIG. 11 is a flowchart illustrating processing of setting the calibration type of a custom sheet in the second embodiment. The processing illustrated in the present flowchart is executed at S603 in FIG. 6 by the sheet data registration unit 401 (CPU 300) of the sheet data management apparatus 100. Note that the processing in FIG. 11 is a flowchart with a new step S1101 added between S703 and S704 in FIG. 7. In other words, processing other than S1101 is the same as in FIG. 7. Note that, in FIG. 11, the same step as in the flowchart in FIG. 7 is denoted by the same step number as the step number in FIG. 7.

First, at S701 to S703, the CPU 300 receives selection of an edit target sheet from a sheet list and determines whether the edit target sheet is a custom sheet and whether the calibration target value 520 is set. In a case where the edit target sheet is not a custom sheet, the CPU transitions to S708. In a case where the edit target sheet is a custom sheet but the calibration target value 520 is not set, the CPU proceeds to S705. In a case where the edit target sheet is a custom sheet and the calibration target value 520 is set, the CPU proceeds to S1101.

At S1101, the CPU 300 determines whether the common calibration sheet suitability 1000 of the sheet kind data 510 of the edit target sheet is set to “yes”. The CPU proceeds to S704 in a case where “yes” is set, or the CPU proceeds to S705 in a case where “no” is set.

In other words, in a case where the common calibration sheet suitability 1000 is set to “yes”, the CPU 300 allows the value of the calibration type 522 of the sheet kind data 510 to be set to either “common” or “individual” at S704. Specifically, the CPU 300 displays the UI 800 (FIG. 8) for setting the calibration type 522 and displays both “individual calibration” and “common calibration” in the pull-down list of the calibration type setting field 804.

In a case where the common calibration sheet suitability 1000 is set to “no”, the CPU 300 allows the value of the calibration type 522 of the sheet kind data 510 to be set only to “individual” at S705. Specifically, the CPU 300 displays only “individual calibration” in the pull-down list of the calibration type setting field 804 on the UI 800 and does not display “common calibration”.

Thereafter at S706, the CPU 300 receives selection of a calibration type by the user. At S707, the CPU 300 updates the calibration type 522 of the sheet kind data 510 in accordance with setting selected by the user and ends the present flowchart.

With the processing according to the second embodiment, only the sheet kind data 510 the calibration type 522 of which is “individual” can be produced with a custom sheet for which the common calibration sheet suitability 1000 is set to “no”. On the other hand, the calibration type 522 can be set to “common” for a custom sheet for which the common calibration sheet suitability 1000 is set to “yes”. Note that, in a case where the common calibration sheet suitability 1000 is set to “yes”, the calibration type 522 can be set to “individual” based on selection by the user.

As described above, in the second embodiment, a sheet for which the calibration type 522 of the sheet kind data 510 is changeable to “common” is restricted based on information of the common calibration sheet suitability 1000. Accordingly, as in the first embodiment, for a custom sheet, the application range of the calibration result can be set based on determination by the user. Moreover, for a custom sheet with no common calibration sheet suitability, the calibration type 522 can be selected as “individual” only, and thus it is possible to prevent execution of the common calibration using a sheet that is not suitable as a common calibration sheet. Accordingly, the custom sheet can be appropriately used as a common calibration sheet.

Note that the functions of the sheet data management apparatus 100 in the present embodiment may be implemented at the printing apparatus 102.

### Third Embodiment

In the second embodiment, as the property information of a custom sheet, the common calibration sheet suitability of the custom sheet is determined based on the value of the common calibration sheet suitability 1000 that is set in the sheet kind data 510 in advance. Information of the common calibration sheet suitability 1000 is the same as information that is preset in the sheet kind data 510 of the reference sheet of a custom sheet.

A third embodiment will be described below with an example in which the sheet data management apparatus 100 sets the common calibration sheet suitability 1000 based on actual physical sheet property information of an edit target custom sheet. The sheet data management apparatus 100 also sets the sheet kind data 510 of the calibration type 522 of the edit target custom sheet based on the value of the common calibration sheet suitability 1000.

The third embodiment will be described below with reference to the accompanying drawings.

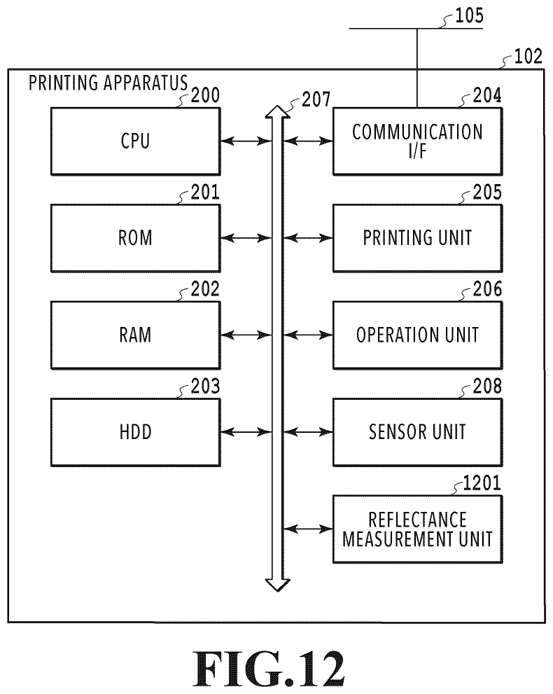

FIG. 12 is a block diagram illustrating the hardware configuration of a printing apparatus 102A according to the third embodiment. The printing apparatus 102A includes a reflectance measurement unit 1201 in addition to the configuration of the printing apparatus 102 according to the first embodiment. The other configuration except for the reflectance measurement unit 1201 is the same as in the first embodiment. In addition, the system configuration of the control system in the third embodiment and the hardware configuration of the sheet data management apparatus 100 are the same as in the first embodiment (FIGS. 1 and 3). In the following description, each component same as in the first embodiment is denoted by the same reference sign and duplicate description thereof is omitted.

The reflectance measurement unit 1201 measures the reflectance of a sheet being fed. A plurality of reflectance measurement units 1201 may be disposed at respective feeding ports of the printing apparatus 102, or only one reflectance measurement unit 1201 may be disposed at a predetermined position. In a case where only one reflectance measurement units 1201 is disposed, the CPU 200 may control so that every sheet is loaded to the position where the reflectance measurement unit 1201 is disposed. Alternatively, the user may set a sheet at the position where the reflectance measurement unit 1201 is disposed. Note that “being fed” means a state in which a sheet is set to the printing apparatus 102. In other words, it is meant that a target sheet exists in the printing apparatus 102.

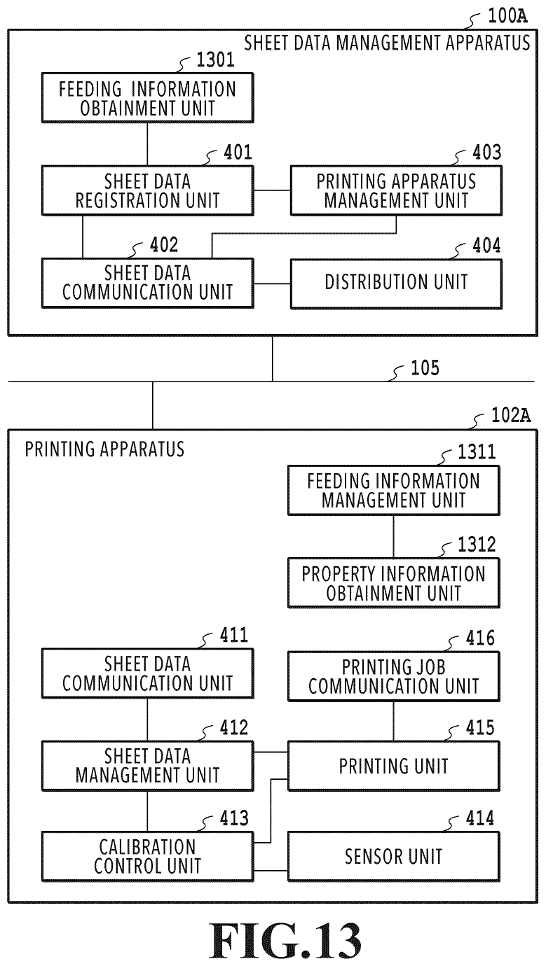

FIG. 13 is a block diagram illustrating the functional configuration of the control system according to the third embodiment. As illustrated in FIG. 13, a sheet data management apparatus 100A and the printing apparatus 102A are connected through the network 105. Difference from the control system (FIG. 4) according to the first embodiment is that the sheet data management apparatus 100A includes a feeding information obtainment unit 1301 and the printing apparatus 102A includes a feeding information management unit 1311 and a property information obtainment unit 1312. In FIG. 13, each component same as in the first embodiment is denoted by the same reference sign.

The sheet data registration unit 401 of the sheet data management apparatus 100A obtains, from the feeding information obtainment unit 1301, information related to a sheet being fed in the printing apparatus 102. The information related to a sheet in the third embodiment includes the kind (sheet ID) and property information of the sheet.

The feeding information obtainment unit 1301 receives, from the printing apparatus 102A through the network 105, the information related to a sheet being fed.

When having received a request from the feeding information obtainment unit 1301 of the sheet data management apparatus 100A through the network 105, the feeding information management unit 1311 of the printing apparatus 102A transmits the kind or glossiness of the sheet being fed. The glossiness is calculated by the feeding information management unit 1311 based on reflectance obtained from the property information obtainment unit 1312.

The property information obtainment unit 1312 obtains the reflectance of the sheet being fed, which is measured by the reflectance measurement unit 1201, and transmits the reflectance to the feeding information management unit 1311.

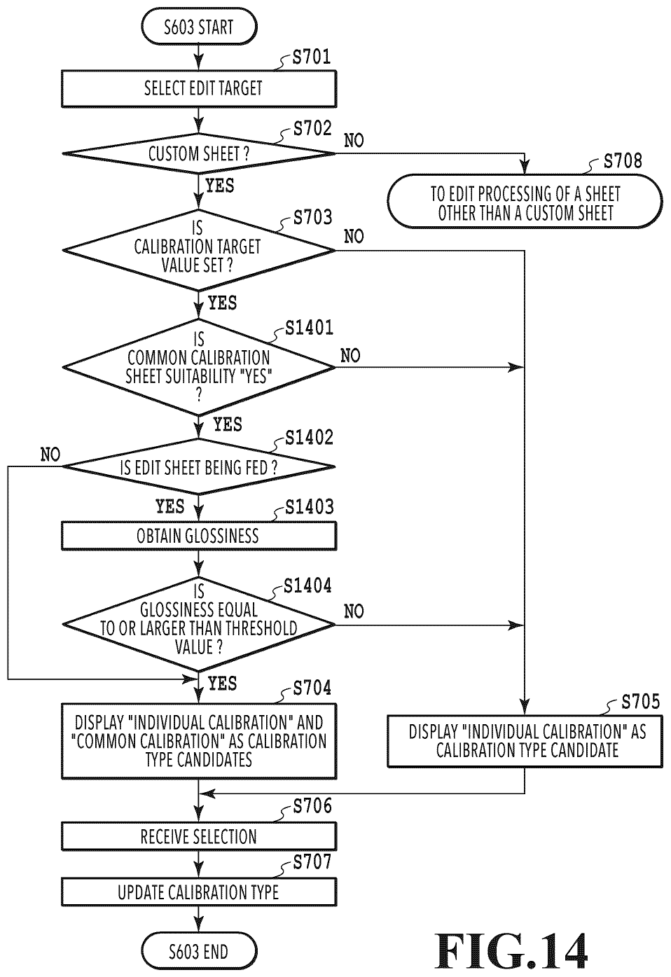

FIG. 14 is a flowchart illustrating processing of setting the application range of calibration for a custom sheet in the third embodiment. The processing illustrated in the present flowchart is executed at S603 in FIG. 6 by the sheet data registration unit 401 (CPU 300) of the sheet data management apparatus 100A. Note that the processing in FIG. 14 is a flowchart with new steps S1401 to S1404 added between S703 and S704 in FIG. 7. In other words, processing other than S1401 to S1404 is the same as in FIG. 7. Note that, in FIG. 14, the same step as in the flowchart in FIG. 7 is denoted by the same step number as the step number in FIG. 7.

First at S701 to S703, the CPU 300 receives selection of an edit target sheet from a sheet list and determines whether the edit target sheet is a custom sheet and whether the calibration target value 520 is set. In a case where the edit target sheet is not a custom sheet, the CPU transitions to S708. In a case where the edit target sheet is a custom sheet but the calibration target value 520 is not set, the CPU proceeds to S705. In a case where the edit target sheet is a custom sheet and the calibration target value 520 is set, the CPU proceeds to S1401.

At S1401, the CPU 300 determines whether the common calibration sheet suitability 1000 in the edit target sheet kind data 510 is set to “yes”. The CPU proceeds to S1402 in a case where “yes” is set, or the CPU proceeds to S705 in a case where “no” is set.

In a case where the common calibration sheet suitability 1000 is set to “yes”, the CPU 300 determines whether an edit target custom sheet is being fed at S1402. Specifically, the CPU 300 (feeding information obtainment unit 1301) transmits a feeding information obtainment request to the printing apparatus 102A. The feeding information obtainment request includes a request for obtaining the sheet ID and glossiness of the edit target sheet. Having received the feeding information obtainment request, the CPU 200 (feeding information management unit 1311) of the printing apparatus 102A first determines whether the ID of the sheet being fed matches a sheet ID included in the feeding information obtainment request. In a case where the sheet IDs do not match, information indicating that the sheet IDs do not match is transmitted as a response to the feeding information obtainment request. Having received the information indicating that the sheet IDs do not match, the CPU 300 (feeding information obtainment unit 1301) proceeds to S704. Processing at S704 and later is the same as processing at S704 and later in FIG. 7.

In a case where the sheet IDs match, in other words, in a case where the edit target custom sheet is being fed, the CPU proceeds to S1403.

At S1403, the property information obtainment unit 1312 of the printing apparatus 102A obtains the reflectance of the sheet being fed and transmits the reflectance to the feeding information management unit 1311. The feeding information management unit 1311 (CPU 200) calculates glossiness from the obtained reflectance based on the JIS standard. The feeding information management unit 1311 transmits the calculated glossiness to the sheet data management apparatus 100A as a response to the feeding information obtainment request.

At S1404, the feeding information obtainment unit 1301 (CPU 300) of the sheet data management apparatus 100A compares the obtained glossiness with a threshold value determined in advance. The threshold value is glossiness that is appropriate as “common calibration sheet”, and is a reference value for determination of whether the sheet is glossy paper, for example. Glossy paper is a high-color-development sheet and has common calibration sheet suitability. For example, the reference glossiness for glossy paper is determined to be an appropriate value of “50” in advance. Note that the value of the reference glossiness is not limited to 50 but may be other values.

In a case where the obtained glossiness does not exceed the threshold value in the determination at S1404 (NO at S1404), it is determined that the sheet does not have common calibration sheet suitability, and the CPU proceeds to S705. In a case where the obtained glossiness is equal to or larger than the threshold value in the determination at S1404 (YES at S1404), it is determined that the sheet satisfies common calibration sheet suitability, and the CPU proceeds to S704.

In other words, in a case where the common calibration sheet suitability 1000 is set to “yes”, the CPU 300 allows the value of the calibration type 522 of the sheet kind data 510 to be set to either “common” or “individual” at S704. Specifically, the CPU 300 displays the UI 800 (FIG. 8) for setting the calibration type 522 and displays both “individual calibration” and “common calibration” in the pull-down list of the calibration type setting field 804.

In a case where the common calibration sheet suitability 1000 is set to “no”, the CPU 300 allows the value of the calibration type 522 of the sheet kind data 510 to be set only to “individual” at S705. Specifically, the CPU 300 displays only “individual calibration” in the pull-down list of the calibration type setting field 804 on the UI 800 and does not display “common calibration”.

Thereafter at S706, the CPU 300 receives selection of a calibration type by the user. At S707, the CPU 300 updates the calibration type 522 of the sheet kind data 510 in accordance with the setting selected by the user and ends the present flowchart.

As described above, in the third embodiment, the sheet data management apparatus 100A obtains sheet glossiness as actual physical sheet property information of the edit target sheet and controls the application range of calibration based on the obtained glossiness. Accordingly, in addition to the effects of the second embodiment, it is possible to highly accurately determine existence of common calibration sheet suitability. Note that the functions of the sheet data management apparatus 100A in the present embodiment may be implemented at the printing apparatus 102A.

### Fourth Embodiment

In the first to third embodiments, the calibration type 522 of the sheet kind data 510 is changed by using the sheet data edit function of the sheet data management apparatus 100. Then, sheet data including the changed the sheet kind data 510 is distributed to the printing apparatus 102, and sheet data in the printing apparatus 102 is updated to new sheet data before calibration is executed. A fourth embodiment will be described below with an example in which sheet data is not updated and the calibration type 522 of the sheet kind data 510 is set during calibration execution.

The fourth embodiment will be described below with reference to the accompanying drawings. Note that the system configuration of the control system according to the fourth embodiment is the same as in the first embodiment (FIG. 1). The hardware and functional configurations of the printing apparatus 102A according to the fourth embodiment are the same as in the third embodiment (FIGS. 12 and 13). The hardware configuration of a sheet data management apparatus 100B according to the fourth embodiment is the same as in the first embodiment (FIG. 3).

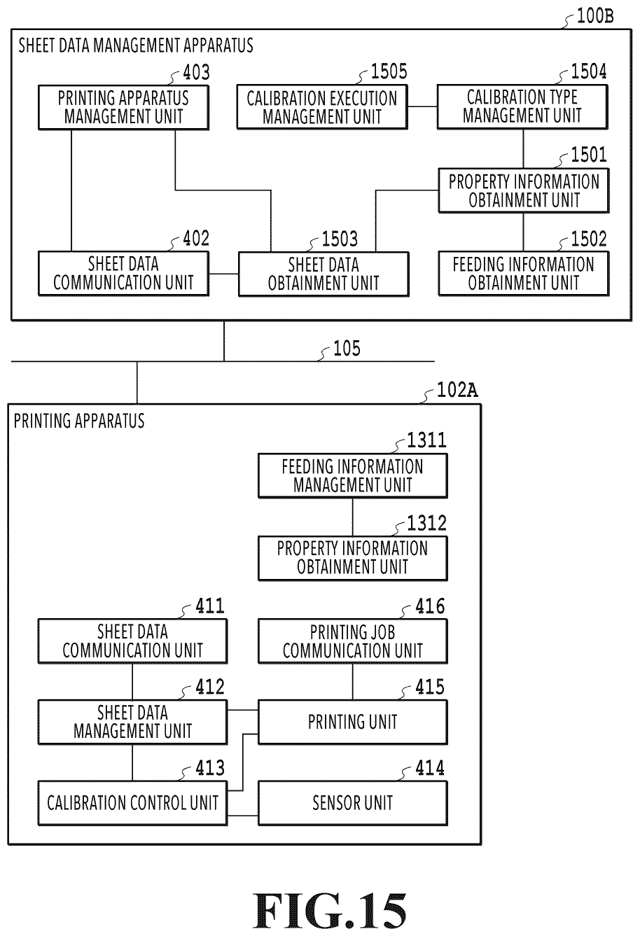

FIG. 15 is a block diagram illustrating the functional configuration of the control system according to the fourth embodiment. In the control system, the sheet data management apparatus 100B and the printing apparatus 102A are connected through the network 105.

The printing apparatus 102A has the same functional configuration (FIG. 13) as the printing apparatus 102A according to the third embodiment.

The sheet data management apparatus 100B includes the sheet data communication unit 402, the printing apparatus management unit 403, a property information obtainment unit 1501, a feeding information obtainment unit 1502, a sheet data obtainment unit 1503, a calibration type management unit 1504, and a calibration execution management unit 1505. Difference from the sheet data management apparatus 100 according to the first embodiment is that the sheet data registration unit 401 is omitted and the property information obtainment unit 1501, the feeding information obtainment unit 1502, the sheet data obtainment unit 1503, the calibration type management unit 1504, and the calibration execution management unit 1505 are added. The sheet data communication unit 402 and the printing apparatus management unit 403 are the same as in the first embodiment.

The feeding information obtainment unit 1502 obtains, from the printing apparatus 102A through the network 105, sheet information related to a sheet being fed. The information related to a sheet in the fourth embodiment includes the kind (sheet ID) and property information of the sheet. The property information is, for example, glossiness.

The sheet data obtainment unit 1503 obtains the value of the common calibration sheet suitability 1000 that is set in the sheet kind data 510 of the sheet being fed.

The property information obtainment unit 1501 obtains the kind (sheet ID) and property information (glossiness) of the sheet being fed, which are obtained by the feeding information obtainment unit 1502 and the common calibration sheet suitability 1000 of the sheet being fed, which is obtained by the sheet data obtainment unit 1503. Hereinafter, information of the kind (sheet ID), glossiness, and common calibration sheet suitability 1000 of the sheet being fed, which are obtained by the property information obtainment unit 1501 is referred to as “information related to the sheet being fed”.

The calibration type management unit 1504 determines whether the sheet being fed is a sheet with which the common calibration is executable, based on the information related to the sheet being fed, which is obtained by the property information obtainment unit 1501.

The calibration execution management unit 1505 controls execution and stop of calibration at the printing apparatus 102A. The calibration execution management unit 1505 displays an UI 1600 for the user to instruct the type of calibration to be executed. On the UI 1600, the user can select the type of calibration to be executed. The calibration execution management unit 1505 instructs the printing apparatus 102A to executes calibration of the type selected by the user on the UI 1600.

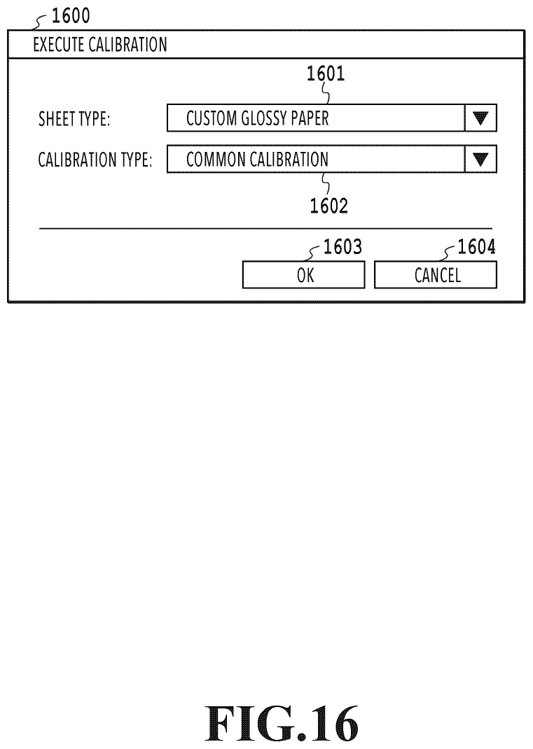

FIG. 16 is a diagram illustrating an example of the UI 1600 for the user to instruct execution of calibration. The UI 1600 includes a setting field 1601 for selecting a sheet kind, and a setting field 1602 for selecting a calibration type. The setting field 1602 for selecting a calibration type displays executable calibration types in a pull-down list format. The display contents of the pull-down list are controlled by the CPU 300 of the sheet data management apparatus 100B in accordance with processing illustrated in a flowchart to be described below.

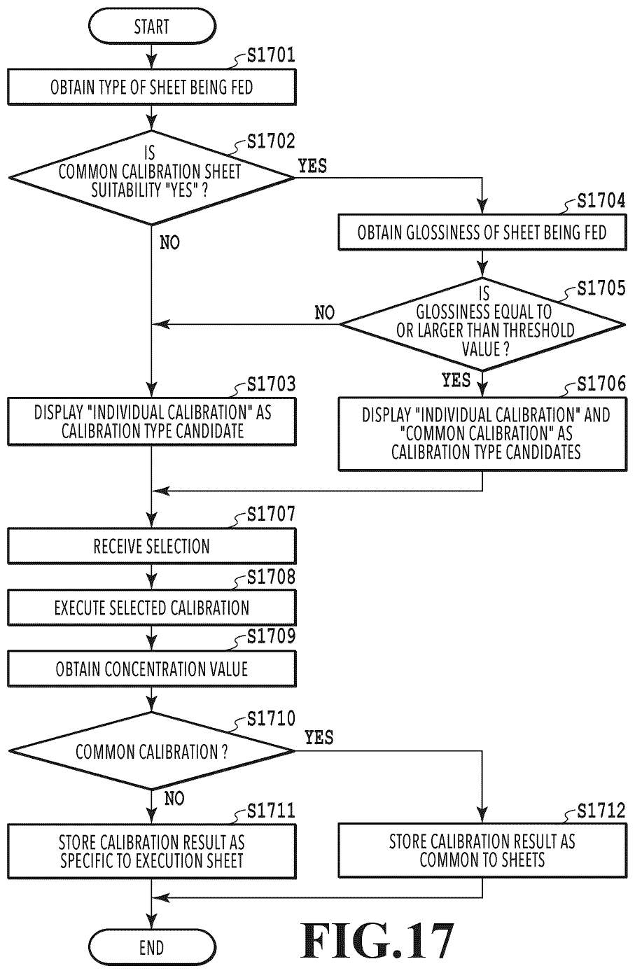

FIG. 17 is a flowchart illustrating the process of calibration control processing in the fourth embodiment. S1701 to S1708 illustrated in the present flowchart are executed by the calibration execution management unit 1505 (CPU 300) of the sheet data management apparatus 100B. S1709 to S1712 are executed by the calibration control unit 413 (CPU 200) of the printing apparatus 102A. Once execution of calibration is instructed by the user of the sheet data management apparatus 100B, the calibration execution management unit 1505 (CPU 300) of the sheet data management apparatus 100B starts the calibration control processing described below.

At S1701, the CPU 300 of the sheet data management apparatus 100B obtains the kind (sheet ID) of a sheet being fed from the feeding information management unit 1311 of the printing apparatus 102A through the network 105.

Subsequently at S1702, the CPU 300 refers to the sheet kind data 510 corresponding to the obtained kind (sheet ID) of the sheet being fed. Then, whether the sheet being fed has common calibration sheet suitability is determined based on the value of the common calibration sheet suitability 1000 included in the sheet kind data 510.

In a case where the value of the common calibration sheet suitability 1000 is “no” (NO at S1702), the CPU proceeds to S1703. At S1703, the CPU 300 displays the UI 1600 for instructing execution of calibration. The CPU 300 displays only “individual calibration” as a calibration type candidate in a pull-down list in the setting field 1602 of the UI 1600.

In a case where the value of the common calibration sheet suitability 1000 is “yes” (YES at S1702), the CPU proceeds to S1704. At S1704, the CPU 300 obtains the glossiness of the sheet being fed. Processing of obtaining glossiness is the same as processing at S1403 according to the third embodiment. Specifically, the CPU 300 (feeding information obtainment unit 1502) transmits a glossiness obtainment request to the printing apparatus 102A. Having received the glossiness obtainment request, the CPU 200 (feeding information management unit 1311) of the printing apparatus 102A obtains the reflectance of the sheet being fed, which is used for calibration, from the property information obtainment unit 1312 and transmits the obtained reflectance to the feeding information management unit 1311. The feeding information management unit 1311 (CPU 200) calculates glossiness from the obtained reflectance based on the JIS standard. The feeding information management unit 1311 transmits the calculated glossiness to the sheet data management apparatus 100B as a response to the feeding information obtainment request.

At S1705, the feeding information obtainment unit 1502 (CPU 300) of the sheet data management apparatus 100B compares the obtained glossiness with a threshold value determined in advance. As in the third embodiment, the threshold value is glossiness that is appropriate as common calibration sheet, and is a reference value for determination of whether the sheet is glossy paper, for example.

In a case where the obtained glossiness does not exceed the threshold value in the determination at S1705 (NO at S1705), it is determined that the sheet does not have common calibration sheet suitability, and the CPU proceeds to S1703.

In a case where the obtained glossiness is equal to or larger than the threshold value in the determination at S1705 (YES at S1705), it is determined that the sheet has common calibration sheet suitability, and the CPU proceeds to S1706.

At S1706, the CPU 300 displays the above-described UI 1600 displays “individual calibration” and “common calibration” as calibration type candidates in a pull-down list of in the setting field 1602 of the UI 1600.

Thereafter at S1707, the CPU 300 receives selection of the type of calibration to be executed from the pull-down list of the UI 1600.

At S1708, the CPU 300 instructs the printing apparatus 102A to execute calibration of the type selected by the user. Note that, in a case where only “individual calibration” is displayed in the pull-down list in the setting field 1602, the CPU 300 may skip S1703 and S1707 and instruct start of the individual calibration at S1708.

The CPU 200 of the printing apparatus 102A executes calibration of the type selected by the user in accordance with the instruction transmitted from the sheet data management apparatus 100. Specifically, the calibration control unit 413 (CPU 200) instructs the printing unit 415 to print a patch, and accordingly, the patch is printed by the printing unit 415.

At S1709, the sensor unit 414 of the printing apparatus 102A obtains the concentration value of the printing result. The calibration control unit 413 (CPU 200) determines correction data based on the obtained concentration value and the calibration target value 520. Hereinafter, the correction data is referred to as a calibration result.

At S1710, the calibration control unit 413 (CPU 200) determines whether the calibration start instruction transmitted from the sheet data management apparatus 100 at S1708 is “common calibration” or “individual calibration”. In a case where the instruction is not “common calibration”, the CPU proceeds to S1711.

At S1711, the calibration control unit 413 (CPU 200) stores the calibration result determined at S1709 in the HDD 203 as a calibration result that is specific to the sheet with which the calibration is executed.

In a case of having determined that the instruction is “common calibration” in the determination at S1710, the CPU proceeds to S1712.

At S1712, the calibration control unit 413 (CPU 200) stores the calibration result determined at S1709 in the HDD 203 as a calibration result that is common to sheets, and ends the present flowchart.

Note that although correction data is stored in the HDD 203 as a calibration result, the concentration value may be stored. In this case, at printing execution, a look-up table (correction data) determined based on the concentration value and the calibration target value is produced and applied to printing data. Moreover, although the storage destination of the calibration result is the HDD 203 of the printing apparatus 102 in the above-described example, the storage destination is not limited to the HDD 203 but may be any storage region where stored data is held and can be obtained at printing execution.

As described above, in the fourth embodiment, common calibration sheet suitability is determined based on the actual property information (for example, glossiness) of a sheet being fed at the timing at which execution of calibration is instructed. Then, a UI with which the common calibration can be executed only with a sheet determined to have common calibration sheet suitability is provided. Accordingly, the common calibration is not executed with a custom sheet that does not have common calibration sheet suitability, thereby eliminating such a failure that correction data not applicable to other kinds of sheets is applied to other sheets. Accordingly, the custom sheet can be appropriately used as a common calibration sheet.

According to the fourth embodiment, without edit of the sheet kind data 510 as in the first to third embodiments, the type of calibration with a custom sheet can be selected by the user on a UI with which execution of calibration is instructed. This makes it possible to use either the individual calibration or the common calibration with the same custom sheet.

Note that the functions of the sheet data management apparatus 100B in the present embodiment may be implemented at the printing apparatus 102A.

According to the present disclosure, even for a custom sheet, the result of the color calibration can be commonly applied to other sheets, thereby broadening the usage form of sheet data and improving convenience.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-008545, filed Jan. 24, 2024, which is hereby incorporated by reference wherein in its entirety.

What is claimed is:

1. A control method for an information processing apparatus connected to a printing apparatus, the control method comprising:
registering information related to a target custom sheet that is set to the printing apparatus; and
transmitting the registered information to the printing apparatus,
wherein in the registration, whether to allow a user to select first setting, by which correction information is used at printing on a sheet of a kind other than the target custom sheet, is varied depending on whether a predetermined condition is satisfied, the correction information being obtained by using the target custom sheet pertaining to printing data to be printed by a printing unit of the printing apparatus.

2. The control method according to claim 1, wherein whether the predetermined condition is satisfied is determined based on the kind of the target custom sheet.

3. The control method according to claim 2, wherein whether to allow selection of the first setting varies based on the kind of a sheet designated as a reference in the registration of information related to the target custom sheet.

4. The control method according to claim 1, wherein whether the predetermined condition is satisfied determined based on property information obtained from the target custom sheet.

5. The control method according to claim 1, wherein second setting, by which the correction information is used at printing on a sheet that is set to the printing apparatus, can be selected irrespective of the kind of the custom sheet.

6. The control method according to claim 1, wherein the custom sheet is a sheet different from a sheet provided by a vendor of the printing apparatus.

7. The control method according to claim 1, wherein the first setting is setting for the use at printing on a custom sheet of the same kind as the target custom sheet.

8. The control method according to claim 1, wherein the correction information is a target value of color calibration.

9. The control method according to claim 4, wherein property information obtained from the target custom sheet is the glossiness of the target custom sheet.

10. The control method according to claim 9, wherein the glossiness of the target custom sheet is measured by the printing apparatus.

11. The control method according to claim 1, further comprising transmitting the correction information and one or more parameters that are used to print the target custom sheet to the printing apparatus, wherein the printing apparatus executes printing based on printing data generated based on the correction information and the one or more parameters.

12. An information processing apparatus connected to a printing apparatus, comprising:
at least a processor and at least a memory coupled to the at least the processor and having stored thereon instructions, when executed by the at least the processor, and cooperating to act as:
a registration unit configured to register information related to a target custom sheet that is set to the printing apparatus; and
a transmission unit configured to transmit the information registered by the registration unit to the printing apparatus,
wherein the registration unit varies whether to allow a user to select first setting, by which correction information is used at printing on a sheet of a kind other than the target custom sheet, depending on whether a predetermined condition is satisfied, the correction information being obtained by using the target custom sheet pertaining to printing data to be printed by a printing unit of the printing apparatus.

13. A non-transitory computer readable storage medium storing a program which causes a computer to execute a control method, the computer being connected to a printing apparatus, the control method comprising:
registering information related to a target custom sheet that is set to the printing apparatus; and
transmitting the registered information to the printing apparatus,
wherein in the registration, whether to allow a user to select first setting, by which correction information is used at printing on a sheet of a kind other than the target custom sheet, is varied depending on whether a predetermined condition is satisfied, the correction information being obtained by using the target custom sheet pertaining to printing data to be printed by a printing unit of the printing apparatus.
